(19) United States
(12) Patent Application Publication
(10) Pub. No.: US 2020/0233070 A1
(43) Pub. Date: Jul. 23, 2020

(54) ULTRASONIC WAVE APPARATUS FOR MEASURE OF DISTANCE

(71) Applicant: FOUNDATION OF SOONGSIL UNIVERSITY-INDUSTRY COOPERATION, Seoul (KR)

(72) Inventors: Jin Oh KIM, Seoul (KR); Sung Gu LIM, Hwaseong-si (KR)

(73) Assignee: FOUNDATION OF SOONGSIL UNIVERSITY-INDUSTRY COOPERATION, Seoul (KR)

(21) Appl. No.: 16/682,043

(22) Filed: Nov. 13, 2019

(30) Foreign Application Priority Data
Jan. 22, 2019 (KR) 10-2019-0008184

(51) Int. Cl. G01S 7/521; G01S 13/08

(52) U.S. Cl. CPC G01S 7/521; G01S 13/08

(57) ABSTRACT

An ultrasonic wave apparatus for measuring a distance according to an embodiment of the present disclosure includes: an ultrasonic sensor; and a sensor housing having the ultrasonic sensor mounted on an end therein, having a guide conduit formed in a longitudinal direction, and having a reflective wall connected with the guide conduit and positioned opposite the ultrasonic sensor, in which wedge patterns having a wedge angle may be formed on an inner surface of the guide conduit to increase directivity of an ultrasonic signal that is generated from the ultrasonic sensor.

### CROSS-REFERENCE TO RELATED APPLICATIONS

This application claims the priority of Korean Patent Application No. 10-2019-0008184 filed on Jan. 22, 2019, in the Korean Intellectual Property Office, the disclosure of which is incorporated herein by reference.

### BACKGROUND

### Field

The present disclosure relates to an ultrasonic wave apparatus for measure of distance and, more particularly, to an ultrasonic wave apparatus for measuring a distance, the apparatus being able to accurately measure the distance to a measurement target at a close position because a guide conduit has a structure that prevents generation of superposition of an ultrasonic transmission signal from an ultrasonic sensor and an ultrasonic reception signal reflected by the measurement target.

### Description of the Related Art

In general, an ultrasonic sensor is a sensor that measures the distance to a measurement target by transmitting an ultrasonic signal to the measurement target and then sensing the ultrasonic signal returning from the measurement target. In more detail, it is possible to measure a distance by calculating and measuring a distance that an ultrasonic wave travels on the basis of the time that is taken until the ultrasonic wave is sensed.

Such an ultrasonic sensor can be used for any of solid, liquid, and gas. As applications of the sensor, there are a measurement of the depth of water or a measurement of a water level, a level gauge or a water gauge as for liquid, a measurement of a distance and a thickness from the surface of metal to an internal defect as for solid, etc.

However, according to ultrasonic sensors of the related art, in order to remove an excitation signal from the ultrasonic sensors, there is complication that it is required to continuously apply a signal having a phase of 180 degrees from the excitation signal.

Further, when the initial conditions of the ultrasonic sensors are changed, it is required to measure again an excitation signal and perform setting again, so there is possibility of generation of an error in a measured distance. In particular, the ultrasonic sensors of the related art have limits of a minimum sensing distance about 20 to 50 cm due to superposition of signals, so they have a limit in measuring short distances smaller than the limits.

Further, when the surface of a guide conduit of an ultrasonic sensor is smooth, the surface of the guide conduit reflects an ultrasonic wave and the reflected ultrasonic wave causes superposition or destructive interaction of signals, which may adversely affect the directional characteristic, that is, directivity of the ultrasonic wave.

Accordingly, it is required to develop an ultrasonic wave apparatus for measuring a distance, the apparatus having a new structure that can prevent superposition of an ultrasonic transmission signal and an ultrasonic reception signal and can accurately measure even short distances.

As a relevant prior art, there is Korean Patent No. 10-1421137 (title of invention: ULTRASONIC LEVEL METER, Registration Date: Jul. 14, 2014).

### SUMMARY

Embodiments of the present disclosure provide an ultrasonic wave apparatus for measuring a distance, the apparatus being able to accurately measure the distance to a measurement target at a close position because a guide conduit has a structure that prevents generation of superposition of an ultrasonic transmission signal from an ultrasonic sensor and an ultrasonic reception signal reflected by the measurement target, and being able to prevent superposition or destructive interaction phenomenon of signals due to reflection of an ultrasonic signal because a wedge pattern having a wedge angle is formed on the inner surface of the guide conduit.

The object(s) of the present disclosure is not limited to those described above and (an)other objects may be made apparent to those skilled in the art from the following description.

An ultrasonic wave apparatus for measuring a distance according to an embodiment of the present disclosure includes: an ultrasonic sensor; and a sensor housing having the ultrasonic sensor mounted on an end therein, having a guide conduit formed in a longitudinal direction, and having a reflective wall connected with the guide conduit and positioned opposite the ultrasonic sensor, in which wedge patterns having a wedge angle may be formed on an inner surface of the guide conduit to increase directivity of an ultrasonic signal that is generated from the ultrasonic sensor.

Further, the wedge angles of the wedge patterns according to an embodiment of the present disclosure may be determined in accordance with a driving frequency of the ultrasonic signal that is generated from the ultrasonic sensor.

Further, the wedge patterns according to an embodiment of the present disclosure may be regularly formed on the inner surface of the guide conduit to be parallel with a longitudinal direction of the guide conduit.

Further, the wedge patterns according to an embodiment of the present disclosure may be regularly formed on the inner surface of the guide conduit to be perpendicular to the longitudinal direction of the guide conduit.

Further, the wedge patterns according to an embodiment of the present disclosure may be formed to have a saw tooth-shaped cross-section in order to prevent superposition or destructive interaction of signals due to reflection of the ultrasonic signals.

Further, a distance between the ultrasonic sensor and the reflective wall according to an embodiment of the present disclosure may be 10 to 50 cm and a driving frequency of the ultrasonic signal that is generated from the ultrasonic sensor may be 10 to 50 kHz.

Further, a distance between the ultrasonic sensor and the reflective wall and a distance between the reflective wall and a measurement target may be secured to prevent generation of superposition of the ultrasonic transmission signal from the ultrasonic sensor according to an embodiment of the present disclosure and an ultrasonic reception signal from the measurement target.

Further, the reflective wall according to an embodiment of the present disclosure may be disposed at an angle of 45 degrees with respect to a longitudinal direction of the guide conduit to perpendicularly reflect the ultrasonic signal from the ultrasonic sensor.

According to an embodiment of the present disclosure, since a guide conduit has a structure that prevents generation of superposition of an ultrasonic transmission signal from an ultrasonic sensor and an ultrasonic reception signal reflected by the measurement target, it is possible to accurately measure the distance to a measurement target at a close position.

Further, according to an embodiment of the present disclosure, since the wedge patterns having the wedge angle are formed on the inner surface of the guide conduit, it is possible to prevent superposition or destructive interaction phenomenon of signals due to reflection of ultrasonic signals.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view schematically showing the configuration of an ultrasonic wave apparatus for measuring a distance according to an embodiment of the present disclosure;

FIG. 2 is a view illustrating distance securement of a guide conduit for preventing superposition of ultrasonic transmission signal and reception signal from an ultrasonic sensor shown in FIG. 1;

FIG. 3 is a perspective view of a guide conduit of the ultrasonic wave apparatus shown in FIG. 1;

FIG. 4 is a perspective view showing a longitudinal cross-section of the guide conduit shown in FIG. 3;

FIG. 5 is a perspective view of a guide conduit of an ultrasonic wave apparatus according to another embodiment of the present disclosure; and

FIG. 6 is a perspective view showing a longitudinal cross-section of the guide conduit shown in FIG. 5.

### DETAILED DESCRIPTION OF THE PREFERRED EMBODIMENT

The advantages and/or features of the present disclosure, and methods of achieving them will be clear by referring to the exemplary embodiments that will be describe hereafter in detail with reference to the accompanying drawings. However, the present disclosure is not limited to the exemplary embodiments described hereafter and may be implemented in various ways, and the exemplary embodiments are provided to complete the description of the present disclosure and let those skilled in the art completely know the scope of the present disclosure and the present disclosure is defined by claims. Like reference numerals indicate the same components throughout the specification.

Hereinafter, embodiments of the present disclosure are described in detail with reference to the accompanying drawings.

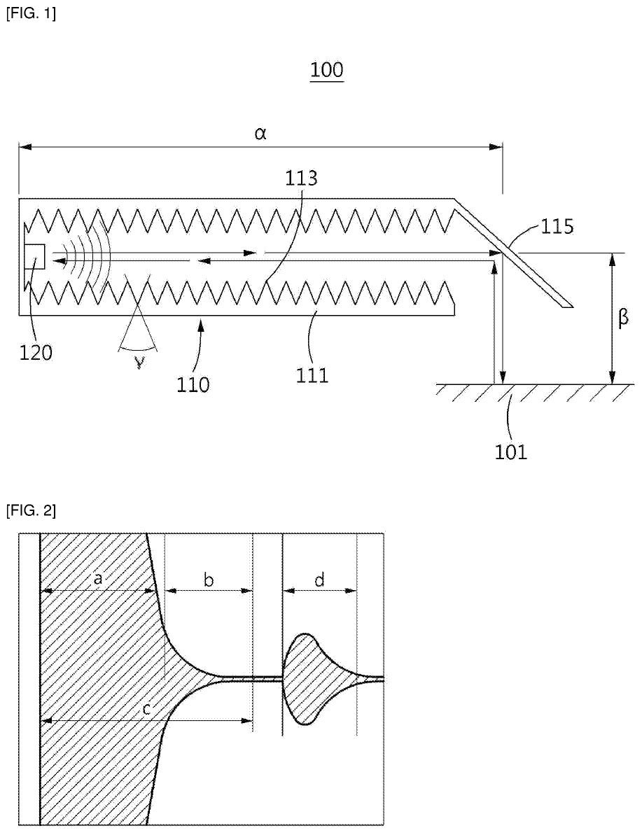

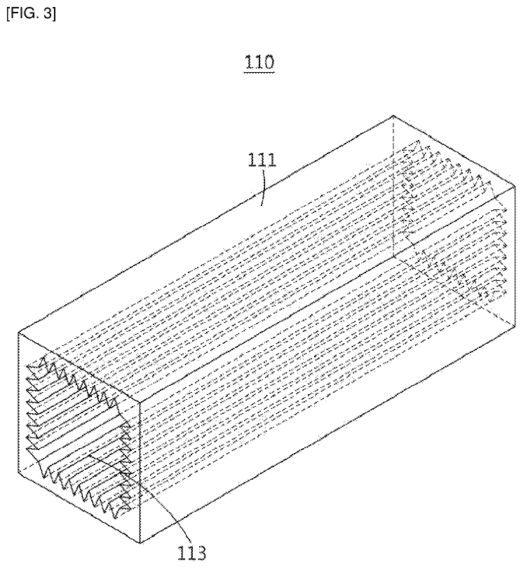

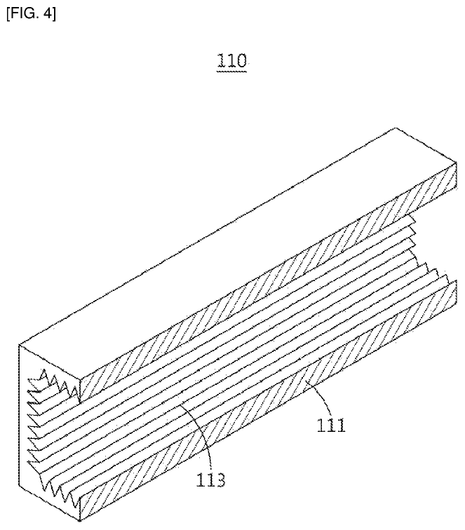

FIG. 1 is a view schematically showing the configuration of an ultrasonic wave apparatus for measuring a distance according to an embodiment of the present disclosure, FIG. 2 is a view illustrating distance securement of a guide conduit for preventing superposition of ultrasonic transmission signal and reception signal from an ultrasonic sensor shown in FIG. 1, FIG. 3 is a perspective view of a guide conduit of the ultrasonic wave apparatus shown in FIG. 1, and FIG. 4 is a perspective view showing a longitudinal cross-section of the guide conduit shown in FIG. 3.

As shown in the figures, an ultrasonic wave apparatus 100 for measuring a distance according to an embodiment of the present disclosure, which is an apparatus that can measure even a very short distance that was difficult to measure using ultrasonic wave apparatuses of the related art, may include an ultrasonic sensor 120, and a sensor housing 110 having the ultrasonic sensor 120 mounted on an end therein, having a guide conduit 111 formed in the longitudinal direction, and having a reflective wall 115 connected with the guide conduit 111 and positioned opposite the ultrasonic sensor 120.

Wedge angles γ may be formed on the inner surface of the guide conduit 111 to increase directivity of an ultrasonic signal that is generated from the ultrasonic sensor 120.

By this configuration, it is possible to prevent superposition of an ultrasonic transmission signal generated from the ultrasonic sensor 120 and an ultrasonic reception signal reflected and returned from a measurement target 101, so it is possible to accurately measure even short distances.

Each of the components is described. The ultrasonic sensor 120 transmits an ultrasonic transmission signal to the measurement target 101 and senses an ultrasonic reception signal reflected by the surface of the measurement target 101, thereby being able to calculate the time taken until the ultrasonic reception signal is sensed after the ultrasonic transmission signal is output. Further, it is possible to calculate the total traveling distance by multiplying the taken time by the speed of the ultrasonic signal.

Referring to FIG. 1, it is possible to measure the distance to the measurement target 101 to be measured in consideration of the horizontal distance α between the ultrasonic sensor 120 and the reflective wall 115 and the distance β between the reflective wall 115 and the surface of the measurement target 101.

However, as described above, since there is an excitation signal that is generated from an ultrasonic sensor in the related art, the accuracy in measurement may be deteriorated by such an excitation signal, and accordingly, generation of an excitation signal should be considered.

Referring to FIG. 2, in the present embodiment, a transmission distance is secured by the guide conduit 111 of the sensor housing 110, so it is possible to prevent an ultrasonic transmission signal ‘a’ and an excitation signal ‘b’ of the transmission signal from being superposed on an ultrasonic reception signal ‘d’. That is, since a transmission distance ‘c’ is secured by the guide conduit 111, the an ultrasonic transmission signal ‘a’ is generated, next, the excitation signal ‘b’ is generated, and then the ultrasonic reception signal ‘d’ is generated after a predetermined interval.

Accordingly, the guide conduit 111 of the ultrasonic wave apparatus 100 according to an embodiment of the present disclosure has a shape and structure considering an excitation signal. That is, as shown in FIGS. 1, 3, and 4, the length of the guide conduit 111 can be determined to prevent generation of superposition of an ultrasonic transmission signal from the ultrasonic sensor 120 and a reflective signal reflected by the measurement target 101.

The length of the guide conduit 111 of the present embodiment, that is, the distance between the ultrasonic sensor 120 and the reflective wall 115 may be 10 to 50 cm, but preferably, may be 30 cm. Further, the length of the guide conduit 111 may be set as the driving frequency of the ultrasonic transmission signal that is generated from the ultrasonic sensor 120. The driving frequency according to the length range of the guide conduit 111, for example, may be 10 to 50 kHz, and when the length of the guide conduit 111 is 30 cm, the driving frequency may be 30 kHz.

By the structure of the guide conduit 111 and the driving frequency of the ultrasonic sensor 120, as described above, it is possible to prevent superposition of the ultrasonic transmission signal that is generated from the ultrasonic sensor 120 and the ultrasonic reception signal that is generated from the measurement target 101, and accordingly, it is possible to accurately measure the distance to the measurement target 101.

On the other hand, the reflective wall 115 connected to the guide conduit 111 of the present embodiment is disposed at an angle of 45 degrees with respect to the longitudinal direction of the guide conduit 111, thereby being able to perpendicularly reflect the ultrasonic transmission signal from the ultrasonic sensor 120. Further, the ultrasonic reception signal reflected by the measurement target 101 can also be reflected by the reflective wall 115 and can accurately reach the ultrasonic sensor 120.

However, the arrangement structure of the reflective wall 115 is not limited thereto, and it is obviously possible to adjust the traveling direction of an ultrasonic signal by adjusting the inclined angle of the reflective wall 115.

The reflective wall 115 may be formed to have sound impedance larger than the sound impedance of air using a material that reflects sound waves. For example, copper, aluminum, or alloys thereof may be used. Further, it is preferable that the surface of the reflective wall 115 is smooth like a mirror, and to this end, polishing may be performed.

Meanwhile, as described above, according to ultrasonic wave apparatuses of the related art, the inner surface of the guide conduit is smooth, so ultrasonic signals is reflected by the inner surface of the guide conduit and accordingly the reflected ultrasonic signals are superposed or destructive interaction, which may adversely affect the directional characteristic, that is, directivity of ultrasonic waves.

Accordingly, wedge patterns 113 having a predetermined wedge angle γ may be formed on the inner surface of the guide conduit 111 of the present embodiment, as shown in FIGS. 1, 3, and 4. That is, since saw tooth-shaped wedge patterns 113 are formed, it is possible to prevent generation of superposition or destructive interaction of signals due to reflection of ultrasonic signals on the inner surface of the guide conduit 111.

Here, the wedge angle γ of the wedge patterns 113 may be determined in accordance with the driving frequency of the ultrasonic transmission signal that is generated from the ultrasonic sensor 120. The degree of inclination of the wedge angle γ of the wedge patterns 113 may be determined in accordance with the driving frequency.

Referring to FIG. 4, the wedge patterns 113 of the guide conduit 111 of the present embodiment may be regularly formed on the inner surface of the guide conduit 111 to be parallel with the longitudinal direction of the guide conduit 111. That is, according to the cross-section shown in FIG. 4, the wedge patterns 113 may entirely have a saw teeth shape, and by this shape, superposition or destructive interaction phenomenon of signals due to reflection of ultrasonic waves can be prevented in the entire area of the guide conduit 111.

As described above, according to an embodiment of the present disclosure, since the guide conduit 111 has a structure that prevents generation of superposition of the ultrasonic transmission signal from the ultrasonic sensor 120 and the ultrasonic reception signal reflected by the measurement target 101, it is possible to accurately measure the distance to the measurement target 101 at a close position.

Further, since the wedge patterns having the wedge angle γ are formed on the inner surface of the guide conduit 111, it is possible to prevent superposition or destructive interaction phenomenon of signals due to reflection of ultrasonic signals.

On the other hand, an ultrasonic wave apparatus 100 for measuring a distance according to another embodiment of the present disclosure is described hereafter, and description of components substantially corresponding to those of the embodiment described above is omitted.

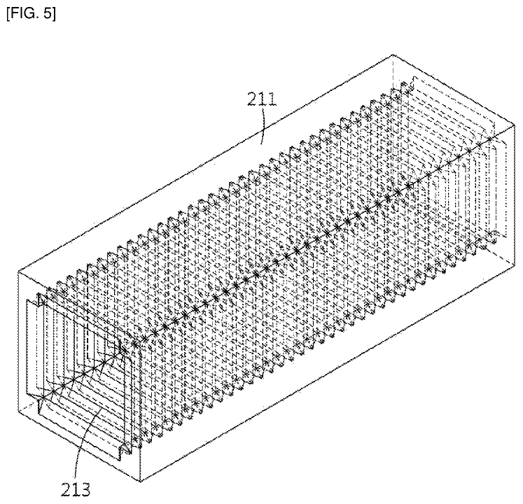

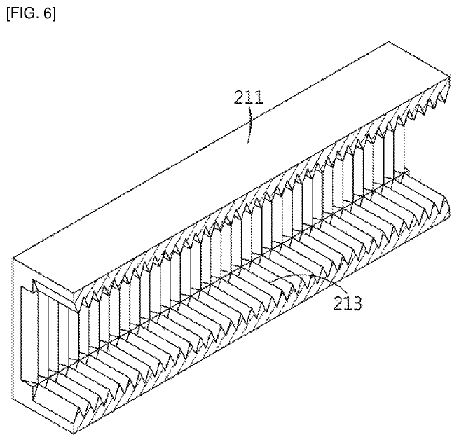

FIG. 5 is a perspective view of a guide conduit of an ultrasonic wave apparatus according to another embodiment of the present disclosure and FIG. 6 is a perspective view showing a longitudinal cross-section of the guide conduit shown in FIG. 5.

As shown in the figures, wedge patterns 213 formed on a guide conduit 211 of the ultrasonic wave apparatus according to another embodiment of the present disclosure, unlike the wedge patterns 113 (see FIG. 1) of the embodiment described above, may be regularly formed on the inner surface of the guide conduit 211 to be perpendicular to the longitudinal direction of the guide conduit 211.

That is, according to the cross-section perpendicular to the longitudinal direction of the guide conduit 211, it can be seen that saw tooth-shaped wedge patterns 213 are formed. The wedge patterns 213 can also prevent generation of superposition or destructive interaction of signals due to reflection of ultrasonic signals on the inner side of the guide conduit 211.

Accordingly, the ultrasonic transmission signal generated from the ultrasonic sensor is accurately transmitted to a measurement target and the ultrasonic reception signal reflected by the measurement target accurately reaches the ultrasonic sensor, so it is possible to accurately measure distances within very close areas.

Although detailed embodiments according to the present disclosure were described above, various modifications are possible without departing from the scope of the present disclosure. Accordingly, the scope of the present disclosure should not be limited to the embodiments described above, and should be defined by not only claims described below, but also equivalents to claims.

Although the present disclosure was described above through a limited embodiment with reference to the drawings, the present disclosure is not limited thereto and may be changed and modified in various ways from the specification by those skilled in the art. Accordingly, the spirit of the present disclosure should be construed only on the basis of claims described below, and equal or equivalent modifications should be all construed as being included in the spirit of the present disclosure.

What is claimed is:

1. An ultrasonic wave apparatus for measuring a distance, the ultrasonic wave apparatus comprising:
an ultrasonic sensor; and
a sensor housing having the ultrasonic sensor mounted on an end therein, having a guide conduit formed in a longitudinal direction, and having a reflective wall connected with the guide conduit and positioned opposite the ultrasonic sensor,
wherein wedge patterns having a wedge angle are formed on an inner surface of the guide conduit to increase directivity of an ultrasonic signal that is generated from the ultrasonic sensor.

2. The ultrasonic wave apparatus of claim 1, wherein the wedge angles of the wedge patterns are determined in accordance with a driving frequency of the ultrasonic signal that is generated from the ultrasonic sensor.

3. The ultrasonic wave apparatus of claim 1, wherein the wedge patterns are regularly formed on the inner surface of the guide conduit to be parallel with a longitudinal direction of the guide conduit.

4. The ultrasonic wave apparatus of claim 1, wherein the wedge patterns are regularly formed on the inner surface of the guide conduit to be perpendicular to a longitudinal direction of the guide conduit.

5. The ultrasonic wave apparatus of claim 1, wherein the wedge patterns are formed to have a saw tooth-shaped cross-section in order to prevent superposition or destructive interaction of signals due to reflection of the ultrasonic signals.

6. The ultrasonic wave apparatus of claim 1, wherein a distance between the ultrasonic sensor and the reflective wall is 10 to 50 cm and a driving frequency of the ultrasonic signal that is generated from the ultrasonic sensor is 10 to 50 kHz.

7. The ultrasonic wave apparatus of claim 1, wherein a distance between the ultrasonic sensor and the reflective wall and a distance between the reflective wall and a measurement target are secured to prevent generation of superposition of the ultrasonic transmission signal from the ultrasonic sensor and an ultrasonic reception signal from the measurement target.

8. The ultrasonic wave apparatus of claim 1, wherein the reflective wall is disposed at an angle of 45 degrees with respect to a longitudinal direction of the guide conduit to perpendicularly reflect the ultrasonic signal from the ultrasonic sensor.
